(19) United States
(12) Patent Application Publication
(10) Pub. No.: US 2024/0309949 A1
(43) Pub. Date: Sep. 19, 2024

(54) GASKETS

(71) Applicant: DUPONT SPECIALTY PRODUCTS USA, LLC, Wilmington, DE (US)

(72) Inventors: Kohtaro Takahashi, Saitama (JP); Norihisa Minowa, Kawasaki (JP)

(21) Appl. No.: 18/268,527

(22) PCT Filed: Dec. 13, 2021
(86) PCT No.: PCT/US2021/063005

§ 371 Date: Jun. 20, 2023

Related U.S. Application Data
(60) Provisional application No. 63/129,148, filed on Dec. 22, 2020.

(51) Int. Cl. F16J 15/10; F16J 15/12; F16J 15/328

(52) U.S. Cl. CPC F16J 15/104; F16J 15/102; F16J 15/128; F16J 15/328

(57) ABSTRACT

Provided herein are gaskets formed from two parts, the first part made from an elastomer, and the second part made from a material having properties with less gas permeation and lower flexibility than the elastomer, in which the second part is fixed to the first part in a direction that is vertical or substantially vertical to the direction of gas permeation between the two components. The gaskets can reduce or prevent permeation by small-molecule gasses; thus, the gaskets are useful, for example, for seals in apparatus for semiconductor wafer process technologies.

### FIELD OF THE INVENTION

The present invention relates to gaskets (especially O-rings) which prevent gas permeation under high-vacuumed conditions, and to methods for forming the gaskets. The gaskets are useful as sealing components used for semiconductor wafer process technologies.

### BACKGROUND OF THE INVENTION

Several patents and publications are cited in this description in order to more fully describe the state of the art to which this invention pertains. The entire disclosure of each of these patents and publications is incorporated by reference herein.

Sealing components (O-rings, gaskets, etc.) are exposed to severe conditions such as high temperature and many kinds of organic solvents and gases, some of which may be corrosive, reactive, or otherwise aggressive. Fluorinated elastomer is widely used for sealing components in various industries because fluorinated elastomer has desirable elasticity and lower chemical reactivity as well as high thermal resistance. Apparatus using a sealing component formed from fluorinated elastomer can achieve high vacuum conditions or pressured conditions, because such sealing component can effectively work, even if it is used under such severe conditions.

Sealing components used for semiconductor manufacturing technologies such as chamber seals for vacuum or vapor deposition process equipment are exposed to peculiar gases (ex. deposition process gas or chamber cleaning gas) and plasma. Such sealing components also require high thermal resistance because the semiconductor wafer process is conducted under high temperature. Although fluorinated elastomer is good candidate for use under severe conditions, based on its excellent properties mentioned above, gas permeation is a problem, because fluorinated elastomer is permeable to a small extent (1×10⁻⁴ Pa) by gasses with small molecules (ex. O₂ or N₂), especially when used under high temperature. Sometimes a full metal gasket is used for such purposes because metal can prevent gas permeation. However, because of the relatively low flexibility of metals, the full metal gasket needs to be carefully seated and bolted into place to be optimally sealed. In addition, when a metal gasket is used, the flange that contacts the metal gasket must be polished to a mirror finish. Another conventional technology is the use of combination of two gaskets, where one is a perfluoro elastomer gasket with high thermal resistance, and the other is a partially fluorinated elastomer gasket with less gas permeation. However, between the two seals, nitrogen gas purge is required; thus, deploying this technology is not an easy operation. Therefore, there remains an urgent need for a flexible sealing component which can prevent permeation of gasses with small molecules.

U.S. Pat. No. 9,290,838B discloses an anti-diffusion metal coated o-ring, in which at least a portion of the surface of the o-ring is coated by a malleable metal coating.

### SUMMARY OF THE INVENTION

Provided herein is a gasket that is useful for semiconductor wafer process technology. The gasket is located between two components, and it can prevent or reduce permeation of gasses with small molecules (ex. O₂ or N₂) between the two components. The gasket of this technology is formed from two parts: the first part is made from an elastomer (fluoro-elastomer, especially perfluoro-elastomer) and the second part is made from a rigid material (such as a metal) with low gas permeation. The second part is strongly fixed with the first part, so that gas permeation between the two components is substantially reduced or prevented entirely.

### BRIEF DESCRIPTION OF THE DRAWINGS

FIG. 1 is a cross sectional view of a portion of one embodiment of the gasket of the invention, which is located between two components to be sealed.

FIG. 1a is the cross-sectional view of FIG. 1 in which the arrows indicate an applied force that seals the two components with the gasket.

FIG. 2 is a cross sectional view of a portion of another embodiment of the gasket of the invention, which is located between two components to be sealed.

FIG. 2a is the cross-sectional view of FIG. 2 in which the arrows indicate an applied force that seals the two components with the gasket.

FIG. 3 is a cross sectional view of a portion of yet another embodiment of the gasket of the invention, which is located between two components to be sealed.

FIG. 3a is the cross-sectional view of FIG. 3 in which the arrows indicate an applied force that seals the two components with the gasket.

FIG. 4 is a top plan view of the gasket of the invention.

FIG. 4a is a side view in cross section of a gasket of the invention.

FIG. 5 is a side view in cross section of a gasket of the invention engaged in a seal with the two components.

FIG. 5a is a perspective view in cross-section of a gasket of the invention engaged in a seal with the two components.

### DETAILED DESCRIPTION OF THE INVENTION

The gasket of the present invention comprises two parts; (A) the first part made from an elastomer, and (B) the second part made from a material having properties with less gas permeation and lower flexibility than the elastomer.

The first part is made from an elastomer. Especially, fluorinated elastomer is preferable because of its excellent properties such as desirable elasticity, less chemically reactive property, good solvent resistance, and high thermal resistance. Fluoroelastomer (FKM) and perfluoroelastomer (FFKM) can be used. Conventional fluoroelastomers comprise copolymerized units of tetrafluoroethylene, vinylidene fluoride or another partially fluorinated comonomer such as fluoro(methyl vinyl ether), e.g., and a cure site monomer. Conventional perfluoroelastomers comprise copolymerized units of tetrafluoroethylene, perfluoro(methyl vinyl ether) and a cure site monomer. Suitable fluoroelastomers include, without limitation, those described in U.S. Pat. No. 8,765,876, issued to Bish et al. Fluoroelastomers may be synthesized by methods described in Kaiser, R. J, et al., “Synthesis of Transparent Fluorocarbon Elastomers: Effect of Crosslinker Type and Electron Beam Irradiation Level on Physical and Mechanical Behavior”, Journal of Applied Polymer Science, Vol. 27, pages 957-968 (1982), and references cited therein. Suitable perfluoroelastomers include, without limitation, those described in U.S. Pat. No. 6,281,296, issued to MacLachlan et al., and U.S. Pat. No. 6,191,208 issued to Kohtaro Takahashi, and may be prepared by methods set forth in these references.

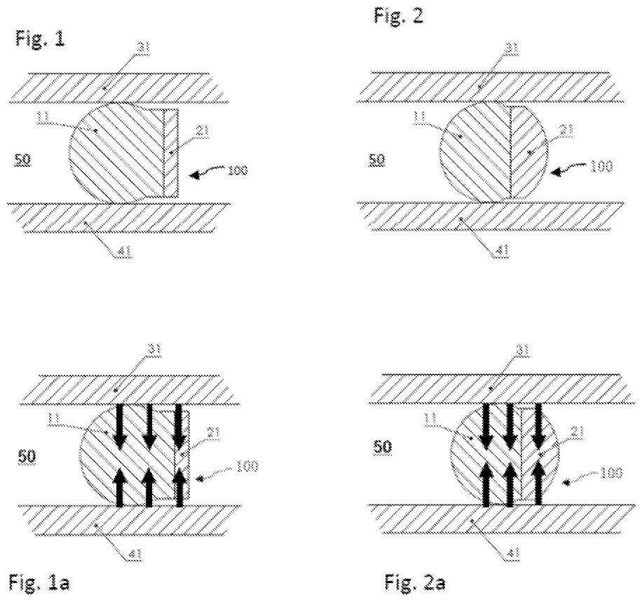

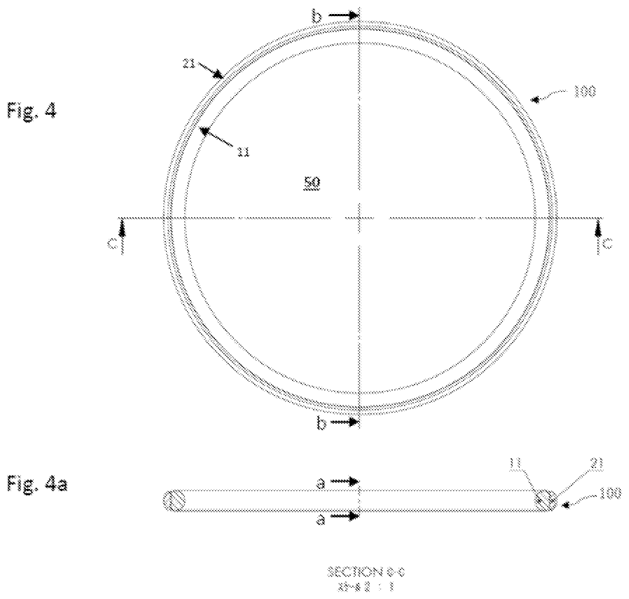

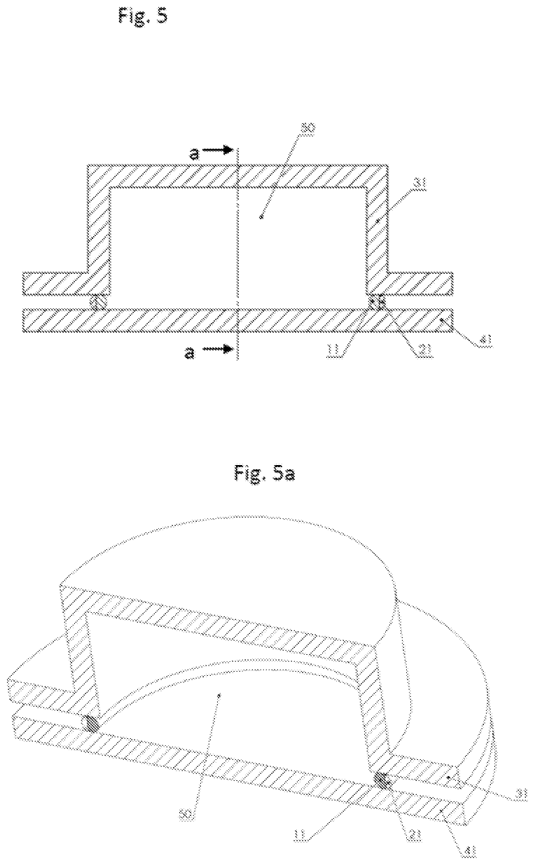

The first part works to prevent gas leakage (i.e. gas diffusion) and maintain high pressure or high vacuum inside an apparatus using the gasket, because of its desirable elastic property. Since the first part is made from flexible materials (elastomer), it provides flexibility for sealing structure and smoothness of the surface of sealing structure, when the gasket is adapted to the sealing components. The first part is compressed to 3 to 40% linear compression ratio, preferably 10 to 30% linear compression ratio, when the gasket is used in a sealing structure and the line is the maximum diameter of the cross-section of the first part that is perpendicular to the radius of the gasket. This line is shown as a-a in FIGS. 4a and 5, for example, and as arrows in FIGS. 1a, 2a, and 3a. As used herein, the term “vertical” refers to a direction that is parallel to line a-a.

The second part is made from a material having properties with less gas permeation and lower flexibility than the elastomer. Any material that satisfies the requirement can be used, but metals and metal alloys are preferable because of their rigidity and lower gas permeation properties. Metals or metal alloys with less reactivity towards chamber cleaning gas or plasma are more preferred. In the point, aluminum or aluminum alloy can be used. Notable metals for use in the second part are Stainless Steel 304, 316 and Aluminum A1000 type, A5000 type and A6000 type. The permeability of these metals to small-molecule gasses, when used in the thicknesses described herein, is believed to be zero or at least substantially zero. As used herein, the term “substantially zero” refers to a pressure that is greater than zero and less than or equal to 1×10⁻⁸ Pa.

The second part has a thickness. The thickness varies depending on the size of the first part and the material of the second part. The thickness should be such that the second part is not broken or subject to irreversible flex deformation by the compression force depicted as arrows in FIGS. 1a, 2a, and 3a when the gasket is located between two components to be sealed. Such ruptures or deformations may be observed by visual inspection. Alternatively, a high rate of gas permeation may indicate that the second part is damaged.

For example, when the second part is made from aluminum, the thickness of aluminum is preferably about 0.2 to about 10 mm, when the diameter of the cross-section of the elastomer (first part) along line a-a is 3.5±0.10 mm. Again, a high rate of gas permeation may indicate that the thickness of the second part is insufficient.

The second part works as a gas permeation barrier for smaller molecular gasses. Although elastomers can basically prevent leakage of air, small amounts of small molecular gas such as oxygen or nitrogen gas are capable of permeating the elastomers. Even a permeability that produces a pressure of 1×10⁻⁴ Torr of nitrogen or oxygen inside a vacuum chamber is sufficient to disrupt some processes, such as vapor deposition processes or semiconductor wafer processes.

Although the second part is made from less flexible materials, it should be fully in contact with the surfaces of both components of the sealing structure. To ensure full contact, the second part can be compressed to less than 5% linear compression ratio in a vertical direction, that is, along the line that is shown as a-a in FIGS. 4a and 5 and as arrows in FIGS. 1a, 2a, and 3a.

The first part of the gasket needs to be strongly bonded to the second part of the gasket.

When the first part is made from perfluoro elastomer and the second part is made from metal or metal alloy, the gasket can be formed by the following steps:
(a) Preparing the metal part (it means the second part, including metal and metal alloy) of the gasket, in which the surface of the metal part to be bonded to perfluoro elastomer is treated chemically or mechanically, and
(b) Compression molding a curable perfluoro elastomer composition onto the surface of the metal part.

In the step (a), the surface of the metal part is chemically or mechanically treated to form strong metal-perfluoro elastomer bonding. Because of the chemical inertness of perfluoro elastomers, bonding of the metal surface to perfluoro elastomers is difficult. Typical examples of chemical pretreatment of metal surface are adhesive primers or bonding agents. Such chemicals can be coated on the surface of the metal part, to improve the bonding strength between perfluoro elastomer and metal parts. Another example of strong bonding between metal and perfluoro elastomers is the use of an anchoring effect, by roughening the surface of the metal, for example, to produce scratches or pores. Acid etching, galvanized chromate treatment, sand blasting, laser etching and anodizing can be used. When the metal is aluminum or an aluminum alloy, the method disclosed in EP1,855,864B, by Minowa et al., can be used to anodize a surface of aluminum (alloy) to form a porous surface.

In the step (b), a curable perfluoro elastomer composition is used to form the perfluoro elastomer part (i.e., the first part) onto the metal part. Normally, the perfluoro elastomers are amorphous polymeric compositions having copolymerized units of at least two principal perfluorinated monomers. Typically, one of the principal comonomers is a perfluoroolefin while the other is a perfluorovinyl ether. Representative perfluorinated olefins include tetrafluoroethylene and hexafluoropropylene. Suitable perfluorinated vinyl ethers include those of the formula (I)

CF2-CFO(RfO)ₙ(Rf′O)ₘRf″ (I)

Where Rf and Rf′ are different linear or branched perfluoroalkylene groups of 2-6 carbon atoms, m and n are independently 0-10, and Rf″ is a perfluoroalkyl group of 1-6 carbon atoms.

Other suitable fluoroelastomers and perfluoroelastomers are described in the above-cited Bish, Kaiser, MacLachlan and Takahashi references.

A curable perfluoro elastomer composition is compression molded onto the porous surface of the metal parts. The mold is in the shape of the gasket. The metal part is positioned in the mold before the curable perfluoroelastomer composition is positioned in the mold. Molding takes place under pressure and at an elevated temperature for a time sufficient to at least partially cure (i.e. vulcanize or crosslink) the perfluoroelastomer and bond it to the metal surface. Bonding is enhanced by perfluoroelastomer compound flowing under pressure into the porous surface structure of the metal prior to crosslinking. Optionally, the resulting perfluoro elastomer-metal part may be post cured at an elevated temperature for a time sufficient to improve the physical properties of the elastomer and the bonding strength of the cured elastomer to the metal surface. Post curing may take place in an air oven or in an inert atmosphere. Typical compression molding conditions are 4 to 8 minutes at a temperature between 180 and 220 degrees C. Typical post cure conditions are 5 to 48 hours at a temperature between 250 to 315 degrees C. Similar molding processes have been described in the above-cited MacLachlan and Takahashi patents.

When in use, for example to form a seal for a vacuum chamber or a pressurized vessel, the gasket is located between the two components to seal a gap (opening) of the two components. Preferably, the first and second parts are situated so that, when the gasket is seated as a seal between the two components, the first part is proximal to the vacuum side of the two components, and the second part is proximal to the external atmosphere side of the two components, such that gas permeation between the two components is reduced or prevented.

Referring now to the drawings, wherein like reference numerals designate corresponding structure throughout the views, and referring in particular to FIG. 1, a cross sectional view of one embodiment of the gasket (100) of the invention is shown. The gasket (100) is formed from an elastomer (11) and a metal (21), preferably aluminum, which are strongly connected to each other. The gasket (100) is located between two components (31, 41), to seal the gap between the two components (31, 41). When the gasket is used for semiconductor manufacturing technologies, the inner, elastomer side (11) of the gasket (100) is exposed to vacuum or to peculiar gases (such as deposition process gas or chamber cleaning gas) and plasma that are present in the interior (50) of the sealed components. The metal or metal alloy (21), which is the second part, is located on the outer side of the gasket (100) to prevent gas permeation. The metal or metal alloy part (21) is located in the vertical direction that is perpendicular to the surface of the two components (31, 41).

Stated alternatively, wherein the second part (21) is fixed to the first part (11), the first and second parts are situated so that, when the gasket (100) is seated as a seal between the two components (31, 41), the first part (11) is proximal to the vacuum or processing side (50) of the two components (31, 41), and the second part (21) is proximal to the external atmosphere side of the two components (31, 41), such that gas permeation into the space (50) defined by the two components (31, 41) is reduced or prevented.

FIG. 2 shows a cross sectional view of another embodiment of a gasket (100) which is formed from a metal part (21) and an elastomer part (11). As in FIG. 1, the metal part is located on the outer side and the elastomer part is located on the inner side (50) of the gasket. In addition, the cross sectional view of the gasket is approximately circular in shape. Advantageously, the whole figure of the gasket depicted in FIG. 2 is similar to the shape of a conventional gasket formed from fluorinated elastomer, for example a torus or O-ring. Thus, the gasket depicted in FIG. 2 can be applied to the conventional use, providing an improved seal as described above without elaborate and expensive re-tooling to change the structure of the sealing components (31, 41) of the current apparatus.

Notably, in FIGS. 1 and 2, the interface of elastomer (11) and metal (21) is a cylinder with a circular cross-section of constant diameter and a vertical axis, that is, an axis that is perpendicular to the plane of the gasket and the surface of the two components (31, 41)

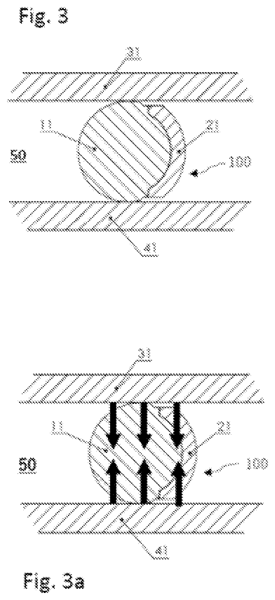

Referring now to FIG. 3, a cross sectional view of another embodiment of the invention is shown, in which the gasket (100) is located between the two components (31, 41) to be sealed. As in FIG. 1 and FIG. 2, the elastomer part (11) is located on the inner side of the gasket, proximal to the interior (50) of the sealed chamber. Also as in FIG. 2, the whole figure of the gasket (100) is similar to that of a conventional gasket. The embodiments of FIGS. 1 and 2 are distinguished from the embodiment of FIG. 3, however, by the shape of the interface of elastomer (11) and metal (21). The interface of elastomer and metal in FIG. 3 is not accurately described as a cylinder with a circular cross-section of constant diameter and a vertical axis, that is, an axis that is perpendicular to the surface of the two components (31, 41). Rather, the interface is curved in shape. Its cross-section is circular; however, its diameter is not constant with respect to the distance between the sealing components (31, 41). Any shape of the interface is suitable for use in the present direction, provided that full contact and an adequate bond between the elastomer (11) and the metal (21) may be achieved by the methods described herein.

Referring now to FIGS. 1a, 2a, and 3a, the embodiments of FIGS. 1, 2, and 3, respectively, are reproduced with the addition of arrows that indicate the sealing force, which is applied to sealing components (31, 41) in a vertical direction. In all three of the depicted embodiments, the second part (21) is located in a vertical direction to the direction for gas permeation between the two components. Gas that moves from the exterior of the sealed chamber to its interior (50) must travel in a direction that is described by a vector having a component that is perpendicular to the vertical direction indicated by the arrows.

Those of skill in the art are capable of designing metal parts (21) that are adapted to the application of a force having a specified magnitude and direction with a pre-determined linear compression. The design choices include the selection of a metal and cross-section for the metal part (21). For example, compared to the gasket (100) of FIGS. 1 and 1a, a gasket (100) such as that shown in FIGS. 2 and 2a may be used in seals that require the application of greater than typical force in the vertical direction, and a gasket (100) such as that shown in FIGS. 3 and 3a may be used in seals that require the application of less than typical force in the vertical direction.

Referring now to FIG. 4, a plan view of the gasket 100 shows lines b-b and c-c in the plane of the gasket 100. In addition, elastomeric part 11 is proximal to the interior 50 of the sealed components (31, 41), which sealed components are not shown in FIG. 4.

Referring now to FIG. 4a, this cross-section of the gasket 100 shows the vertical axis a-a, which is perpendicular to lines b-b and c-c in the plane of the gasket. Lines b-b and c-c are not shown in FIG. 4a.

Referring now to FIG. 5, a sealed structure comprises two sealing components (31, 41) and the gasket (100). Each component (31, 41) has a surface that is parallel to a surface on the other component, and the gasket (100) is placed between the two parallel surfaces to seal the components (31, 41) and to prevent gas leakage into the interior (50). The second part (21) is fixed to the first part (11) a direction that is vertical to the direction of the parallel surfaces of the components (31, 41). Stated alternatively, the second part (21) is fixed to the first part (11) a direction that is parallel to line a-a.

Referring now to FIG. 5a, the perspective view in cross-section of a gasket (100) engaged in a seal with the two components (31, 41) depicts the second part (21) forming a continuous contact with the surface of each component (31, 41).

Although gaskets in a circular shape, such as a torus or an O-ring, are depicted in FIGS. 4 and 5a, the gaskets of the invention may have any shape that is known for gaskets or required by the design of the equipment to be sealed. Other conventional shapes for gaskets include oval shapes and rectangles, for example squares, with rounded corners.

Although not depicted in the drawings, either or both sealing components (31, 41) may be equipped with one or more apertures in addition to the aperture that is sealed by the gasket of the invention. These aperture(s) may be sealed against gas permeation by gaskets of the invention or by other means. For example, the sealing components (31, 41) may be equipped with apertures for gas inlet valves, vacuum ports, or openings through which instruments may be inserted, including without limitation heaters, pressure gauges, electrodes, and probes, such as temperature probes, Langmuir probes, or QMS probes.

The following examples are provided to describe the invention in further detail. These examples, which set forth a preferred mode presently contemplated for carrying out the invention, are intended to illustrate and not to limit the invention.

### EXAMPLES

### Test Samples

Test sample 1: new developed Gasket shown in FIG. 1

Test sample 2: new developed Gasket shown in FIG. 2

Test sample 3: conventional O-ring formed from perfluoro elastomer (AS568 228 O-ring in FFKM)

Test sample 4: conventional O-ring formed from fluorinated elastomer (AS568 228 O-ring in FKM)

Test Sample 1 and 2 were bonded parts of FFKM (11) and Aluminum (21) prepared by co-cure molding process. The curable perfluoroelastomer was prepared according to methods described in U.S. Pat. Nos. 6,281,296 and 6,191,208 and in European Patent No. EP1,855,864B, cited above. The bonding method is also disclosed by EP1,855,864B. Test samples 3 and 4 were obtained from commercial sources.

### Test Equipment and Method of Gas Permeation Through a Vacuum Seal.

### Test-1

The test equipment is a vacuum chamber that has AS568 228 O-ring size flange in Stainless Steel for vacuum seal. Vacuum pump and QMS (Quadrupole mass spectrometer) are equipped on the chamber. A Ribbon Heater was put around the chamber and a Mantle Heater with Thermostats was put around the flange for heating the equipment to more than 200° C.

The two-part gasket of Test sample (Test sample 1, 3 and 4) was put into the flange of the equipment for sealing in Vacuum. The chamber was pumped to ultra-vacuum level of 1×10⁻⁷ Pa with a Ribbon heater around the chamber set at 100° C. The Ribbon heater keep heating the chamber at 100° C. all the time. When the Mantle heater around the flange was off, the flange temperature was 52° C. due to heating from a Ribbon heater around the chamber. The vacuum was maintained by continuously running the vacuum pump. The temperature of the heater around the flange was increased at a rate of 2.5° C./min up to 200° C. by the Mantle heater around the flange while the heater around the chamber remained set at 100° C. The air pressure in the vacuum chamber resulting from permeation through the seal was measured by QMS when the temperature of the heater around the flange registered 100° C., 150° C. and 200° C. The partial pressures of N₂ and O₂ were measured at these temperatures as well.

### Test-2

A flange made from Aluminum was also prepared to run Test sample 2. The temperature to start measurement was 66° C. due to the difference of thermal conductivity between Stainless steel and aluminum. Permeation measurement was run 10 times to ascertain the repeatability against the temperature heat cycles. Because the flange was made from Aluminum, the surface of Test sample 2 was inspected by 3D Image measuring instrument type VHX-7000 of KEYENCE Corp. of Itasca, IL, after the testing to confirm that the flange sustained no physical damage that would render it unfit for repeated use. No surface scratching was observed.

Test Result of Gas Permeation (Air, N₂ and O₂) Rate.

### Test-1

Air permeation rate results are shown in Table 1 while N₂ permeation rate results are shown in Table 2 and O₂ results are in Table 3. All gas permeation rates reported herein are in units of Pascals (Pa).

TABLE 1
Permeation of Air into the Vacuum Chamber

| Flange | Sample-3 | Sample-4 | |
|---|---|---|---|
| Temperature, ° C. | AS-228/FFKM | AS-228/FKM | Sample-1 |
| 52 | 4.15E−05 | 1.82E−05 | 4.10E−05 |
| 100 | 1.64E−04 | 1.08E−04 | 1.32E−04 |
| 150 | 5.00E−04 | 3.57E−04 | 1.70E−04 |
| 200 | 9.98E−04 | 7.02E−04 | 1.54E−04 |

TABLE 2
Permeation of Nitrogen into the Vacuum Chamber

| Flange | Sample-3 | Sample-4 | |
|---|---|---|---|
| Temperature, ° C. | AS-228/FFKM | AS-228/FKM | Sample-1 |
| 52 | 2.05E−05 | 4.09E−06 | 2.21E−05 |
| 100 | 9.88E−05 | 3.66E−05 | 8.93E−05 |
| 150 | 3.26E−04 | 1.74E−04 | 1.18E−04 |
| 200 | 6.85E−04 | 3.82E−04 | 1.06E−04 |

TABLE 3
Permeation of Oxygen into the Vacuum Chamber

| Flange | Sample-3 | Sample-4 | |
|---|---|---|---|
| Temperature, ° C. | AS-228/FFKM | AS-228/FKM | Sample-1 |
| 52 | 1.34E−05 | 3.66E−06 | 1.12E−05 |
| 100 | 5.14E−05 | 1.92E−05 | 2.98E−05 |
| 150 | 1.50E−04 | 7.82E−05 | 3.35E−05 |
| 200 | 2.58E−04 | 9.72E−05 | 2.12E−05 |

### Test-2

Air permeation rate results are shown in Table 4 while N₂ permeation rate results are shown in Table 5 and O₂ results are in Table 6

TABLE 4
Permeation of Air into the Vacuum Chamber

| Flange | | |
|---|---|---|
| Temperature, ° C. | Sample-2 1st | 10th |
| 66 | 7.52E−05 | 6.95E−05 |
| 100 | 9.52E−05 | 8.83E−05 |
| 150 | 1.05E−04 | 9.90E−05 |
| 200 | 1.12E−04 | 1.05E−04 |

TABLE 5
Permeation of Nitrogen into the Vacuum Chamber

| Flange | | |
|---|---|---|
| Temperature, ° C. | Sample-2 1st | 10th |
| 66 | 3.78E−05 | 3.41E−05 |
| 100 | 5.48E−05 | 4.92E−05 |
| 150 | 6.00E−05 | 5.44E−05 |
| 200 | 6.40E−05 | 5.85E−05 |

TABLE 6
Permeation of Oxygen into the Vacuum Chamber

| Flange | | |
|---|---|---|
| Temperature, ° C. | Sample-2 1st | 10th |
| 66 | 1.61E−05 | 1.47E−05 |
| 100 | 1.89E−05 | 1.81E−05 |
| 150 | 2.02E−05 | 1.96E−05 |
| 200 | 1.70E−05 | 1.71E−05 |

No damage to the flange was observed after the completion of Test 2.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A gasket for sealing two components from gas permeation, said gasket comprising
(A) a first part comprising an elastomer, and
(B) a second part comprising a material having less gas permeation and lower flexibility than the elastomer,
wherein the second part is fixed to the first part, and wherein the first and second parts are situated so that, when the gasket is seated as a seal between the two components, the first part is proximal to the vacuum side of the two components, and the second part is proximal to the external atmosphere side of the two components, such that gas permeation between the two components is reduced or prevented.

2. The gasket of claim 1, wherein the second part is located in a vertical direction to the direction for gas permeation between the two components.

3. The gasket of claim 1, wherein the shape of the interface of the first part and the second part is cylindrical.

4. The gasket of claim 1, wherein the first part comprises a fluorinated elastomer.

5. The gasket of claim 1, wherein the first part comprises a perfluoro elastomer.

6. The gasket of claim 1, wherein the second part comprises a metal or a metal alloy.

7. The gasket of claim 1, wherein the second part comprises aluminum or an aluminum alloy.

8. The gasket of claim 7, wherein the interfacial surface of aluminum or aluminum alloy has pores, and at least a portion of the elastomer is inserted into the pores by compression molding.

9. A method for producing a gasket for sealing two components from gas permeation, in which the gasket comprises (A) a first part made from an elastomer, and (B) a second part made from a metal or metal alloy, the method comprises the steps of:
(a) preparing a metal part made from metal or metal alloy, in which the surface of the metal part to be bonded to perfluoro elastomer is treated chemically or mechanically; and
(b) compression molding a curable perfluoro elastomer composition onto the surface of the metal part.

10. A sealing structure comprising two components and the gasket of claim 1, each component has a surface facing in parallel against each other,
wherein the gasket is placed between the two surfaces to seal the components from gas leakage, and
wherein the second part is fixed with the first part in a direction that is vertical to the direction to the direction for gas permeation between the two components.

11. The sealing structure of claim 10, wherein the first part is compressed to 3 to 40% linear compression ratio.

12. The sealing structure of claim 10, wherein the second part forms a continuous contact with the surface of each component.

13. The sealing structure of claim 10, which is used for high vacuum seal of an apparatus used for semiconductor manufacturing process or flat panel display manufacturing process.
